(19) United States
(12) Patent Application Publication
(10) Pub. No.: US 2008/0222299 A1
(43) Pub. Date: Sep. 11, 2008

(54) Method for preventing session token theft

(75) Inventor: Michael Boodaei, Givatayim (IL)

Correspondence Address: MERCHANT & GOULD PC, P.O. BOX 2903, MINNEAPOLIS, MN, 55402-0903, US

(73) Assignee: TRUSTEER LTD., Ramat-Gan (IL)

(21) Appl. No.: 11/714,932

(22) Filed: Mar. 7, 2007

(51) Int. Cl. G06F 15/16

(52) U.S. Cl. 709/229

(57) ABSTRACT

The present invention relates to a method for preventing the theft of a session token comprising the steps of: (a) detecting a submission of a first request from the client's browser to a protected site; (b) redirecting said first request to the traffic processor for monitoring said first request; (c) forwarding said first request from said traffic processor to said protected site; (d) receiving the response containing the session token from said protected site by said traffic processor; (e) storing said session token in the session table; (f) providing a token index for indexing said session token stored in said session table; (g) modifying the content of said response by changing said session token to said token index; and (h) forwarding the modified response from said traffic processor to said browser.

### FIELD OF THE INVENTION

The present invention relates to the field of Internet security, secure browsing, and secure eCommerce. More particularly, the invention relates to a method for preventing the theft of the session token from the user's browser, which is used to identify the user to a web server.

### BACKGROUND OF THE INVENTION

A computer executing a browser, referred to hereinafter as a Web Client or client, is essentially a hyper text reader communicating with a Web Server via a specific data transfer protocol such as a Hyper Text Transfer Protocol (HTTP). Any hyper text file on the web is uniquely identified by its Universal Resource Locator (URL). Many of the hyper text files are currently structured using the Hyper Text Mark-up Language (HTML) which may also be used for calling hyper text data objects. The hyper text data object may be in the form of any information medium including a text, an image, a voice, a moving picture or an executable computer program. When a client requests a hyper text file, using the file's URL, the file is displayed on the client's browser, where the display is commonly known as a web page. The client can return data to the server and call a Common Gateway Interface (CGI) program on the server computer to perform a specific task.

Since HTTP is stateless and since Web servers are accessible by many users, where each user may interact with the Web server in many ways, application designers had to develop a way to track the states of the connecting users. Instead of requesting each user to authenticate upon each click in a Web application, a session token is created on the client's browser, where the session token is used to identify the user. Usually the session token is kept “alive” in the browser as long as the user is logged on to the Web server. Typically, the session token is deleted when the user logs-out from the Web Server or after a predefined period of inactivity. Session tokens are commonly stored in cookies, URLs and hidden fields of Web pages.

As explained the session token is used by the user's browser as an identification string for transmitting to the server. One of the problems concerning Internet security today involves session token thieving which is the act of copying a user session token after the user successfully obtained an authentication session token. Since after the log-in, the web site's server identifies the user solely by his session token, the act of thieving/copying it allows the attacker to browse the Web site with the same privileges of the user, for the duration of the user's session, i.e. until the user actively logs out, or is logged out by the system, due to inactivity.

One of the ways to maliciously copy a session token is “Cross Site Scripting”. This attack exploits a vulnerability of the targeted web site, which allows the attacker to craft a malicious link (in the target web site) and entice the user to click it. Once the user clicks this link, the attacker's Javascript/VBscript code runs at the user's browser in the context of the web site. This malicious code can copy the session token, if it is a cookie or part of a URL, possibly in a different window of the same site and browser).

Another way to maliciously copy a session token is by implementing in the client a “Malicious browser plug-in”. The malicious browser plug-in (e.g. BHO technology in Microsoft Internet Explorer) waits for the user to log in, and then forwards the session token to the attacker's server, where it is collected by the attacker and used to browse the web site with the same privileges as the logged in user.

Today, in general, most attempts to prevent Cross Site Scripting are carried out at the server side, e.g. by sanitizing input and encoding output. However, no silver bullet has so far emerged, and Cross Site Scripting attacks are still prevalent among all attacks reported. Some attempts were made to suggest browser measures to confine and contain the effect of cross site scripting (e.g. “Content Restrictions” and “Script Keys” by Gervase Markham, http://www.gerv.net/security/content-restrictions/ and http://www.gerv.net/security/script-keys/, respectively), but these methods remain at this time experimental and have never made it into the core of any major browser.

As to the virus/spyware/Trojan/malware problem, one approach applied by the Anti-virus and anti-spyware vendors, for combating client side threats (such as malicious browser plug-ins), is detection through signatures, meaning that any virus/spyware/Trojan/malware detected by the vendors is identified and marked by a unique signature for detection. Nevertheless, this reactive approach is unlikely to detect a threat until it was (1) noticed several times by the vendors, (2) analyzed in the vendors' lab and a signature identifying the threat is developed, and (3) the signature is distributed to the clients. This process can take many hours, sometimes days, thereby opening a window large enough for the threat to operate. Although, heuristics and generalization techniques (“behavioral analysis”) exist, they are far from being effective, as the attacker can study them at his convenience and come up with ways to avoid detection.

It is an object of the present invention to provide a method for preventing session token theft.

It is another object of the present invention to provide a method for preventing an unauthorized user from copying a user's session token and falsely identifying as the user to a secure web site.

It is still another object of the present invention to provide a method for preventing session token theft applied by Cross Site Scripting or Malicious browser plug-ins.

Other objects and advantages of the invention will become apparent as the description proceeds.

### SUMMARY OF THE INVENTION

The present invention relates to a method for preventing the theft of a session token comprising the steps of: (a) detecting a submission of a first request from the client's browser to a protected site; (b) redirecting said first request to the traffic processor for monitoring said first request; (c) forwarding said first request from said traffic processor to said protected site; (d) receiving the response containing the session token from said protected site by said traffic processor; (e) storing said session token in the session table; (f) providing a token index for indexing said session token stored in said session table; (g) modifying the content of said response by changing said session token to said token index; and (h) forwarding the modified response from said traffic processor to said browser.

Preferably, the method further comprises the steps of: (i) attaching by the browser the token index to a second request intended for the protected site; (j) redirecting said second request to the traffic processor by the redirector; (k) modifying said second request by replacing said token index of said second response with the corresponding session token from the session table; and (l) forwarding the modified second request to said protected site;

In one of the embodiments, prior to forwarding the first request, modifying said first request by deleting the session token.

In one of the embodiments, the session table stores more than one session tokens.

Preferably, the forwarding of the request(s) by the traffic processor and the receiving of response(s) from the protected site is done using a secure path.

In one of the embodiments, the first request from the client's browser is the login request.

### BRIEF DESCRIPTION OF THE DRAWINGS

In the drawings:

FIG. 1 is a schematic diagram of the system according to one of the embodiments of the invention.

FIG. 2 is a block diagram illustrating the method of the invention according to one of the embodiments.

FIG. 3 is a schematic diagram of the system according to another embodiment of the invention.

### DETAILED DESCRIPTION OF PREFERRED EMBODIMENTS

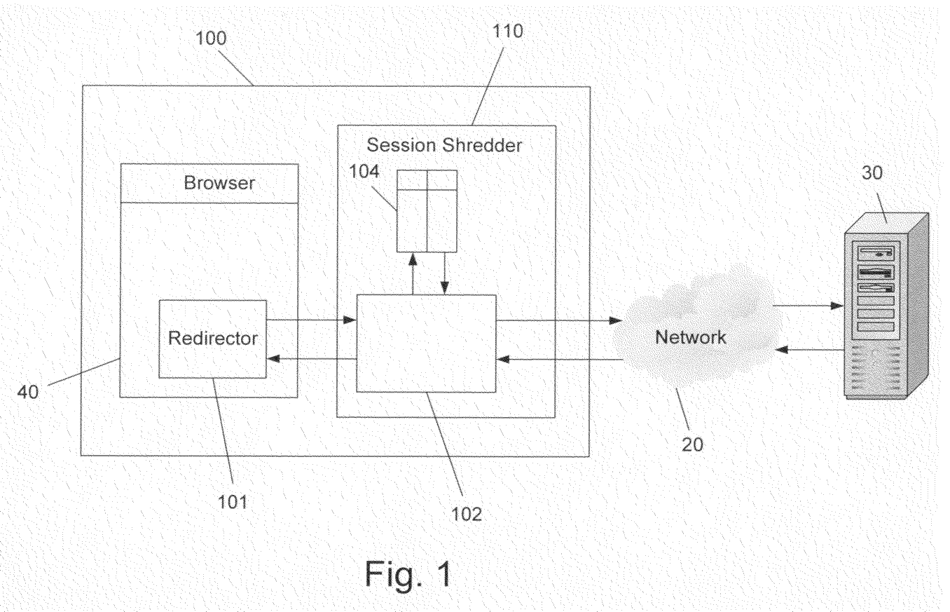

FIG. 1 is a schematic diagram of the system according to one of the embodiments of the invention. In the diagram, client 100 executes a browser 40 when surfing a Network 20 to web server 30. The redirector 101 is installed in browser 40 in order to avert the communication into Session Shredder 110, installed on the client 100, when the browser communicates with a protected site. The Session Shredder 110 purpose is to monitor the flow of data between the browser 40 and the protected site on web server 30 for detecting a transmittal of the session token. In this embodiment Session Shredder 110 comprises 2 components: Session Table 104 for mapping token index(es) to the real session token(es), and Traffic Processor 102 which monitors and manipulates HTTP traffic.

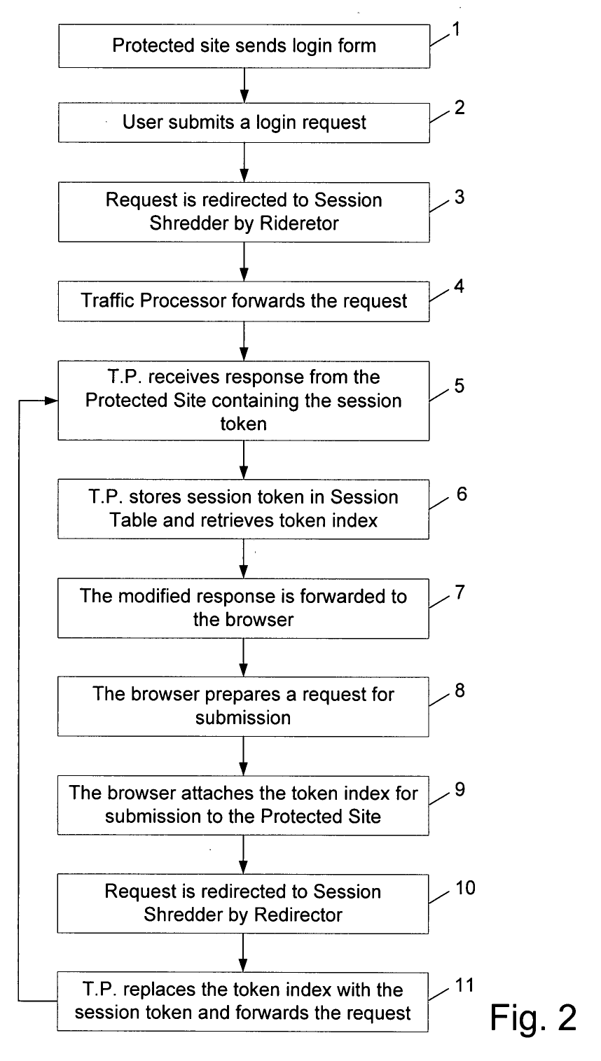

FIG. 2 is a block diagram illustrating the method of the invention according to one of the embodiments. The method is described in relations to FIG. 1. At first the user of computer 100 may surf the Network 20 and may visit web server 30 hosting a protected Web site. In step 1 the web server 30 of the protected site sends a login form to the browser 40 of the user for identification. In step 2 the user fills and submits the login request using his browser 40. In step 3 the Redirector 101 detects the user's attempt to transmit the request to the protected site, and it redirects the request to Session Shredder 110. In step 4 the Traffic Processor (TP) 102 detects that this is a log-in request for a protected site and forwards the request to the protected site. In step 5 TP 102 receives the response from the site, where the response typically contains a session token in some form (cookie, part of URL, hidden field). In step 6 the TP 102 stores the received session token in the Session Table 104, and retrieves a token index. The token index can be any number or sequence for mapping or indexing to the received session token stored in Session Table 104. In step 7 the session token is replaced with the token index in the response and the modified response is forwarded to browser 40. At this point the user may continue to interact with the web site until an action requiring the transmittal of the session token is made, e.g. clicking a URL in that page, or submitting a form. When such an action is required then in step 8 the browser 40 prepares the user request. In step 9 the browser 40 attaches the session information, namely the token index, and attempts to transmit the information. In step 10 the Redirector 101 detects that the browser 40 attempts to access a protected site and it redirects the request to the Session Shredder 110. In step 11 the TP 102 replaces the token index with its corresponding session token from the Session Table 104 and forwards the request to the protected site. When a response is received from the protected site it is handled as described in relations to steps 5-7. The method, as described in relation to steps 5-11 may be repeated indefinitely until the user logs out of the protected site or terminates his connection.

In one of the embodiments the user may connect to a number of protected sites in which the method of the invention is applied to each of the sites individually. As described, the session table may store a number of session tokens where each session token of each protected site is indexed by its corresponding index token.

In one of the embodiments the protected web page is part of a broader unprotected web site where the user receives a session token from the unprotected web site. In this embodiment, as long as the user continues to surf the unprotected web page no need arises to change the session token. However, once the user enters the protected web page and submits a login request to the protected page the redirector redirects the request the TP in the session shredder. In this embodiment the TP removes the session token from the request and forwards the request to the protected web site without the session token. Thus, once the protected web site receives the request without a session token it automatically generates a new session token and attaches it to the returning response, effectively allowing the TP to store the new session token, retrieved from the received response, without revealing it to the browser.

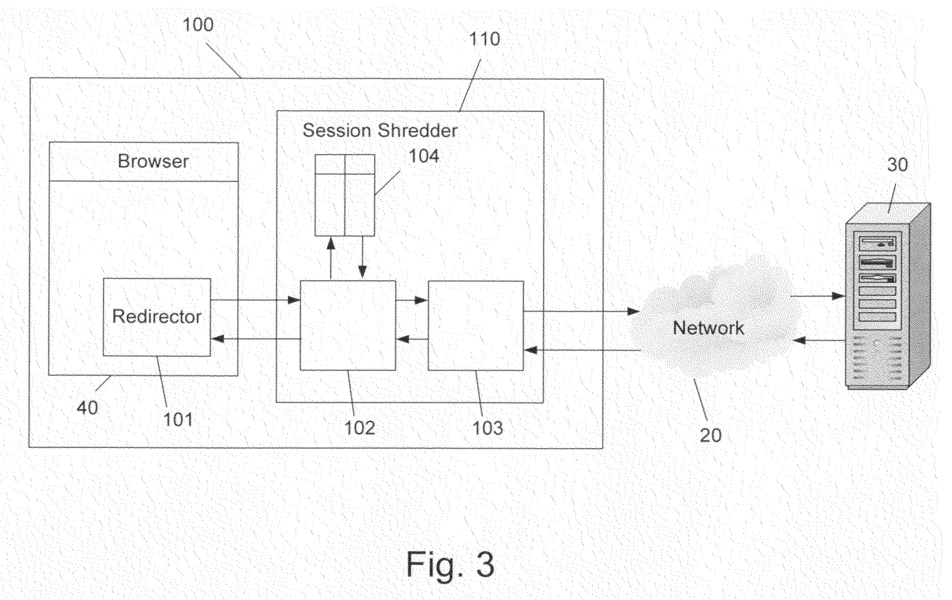

FIG. 3 is a schematic diagram of the system according to another embodiment of the invention. In the diagram client 100 executes a browser 40 when surfing the Network 20 to web server 30. Redirector 101 is a module that forces the browser to avert the traffic transmitted to and from the protected site through Session Shredder 110. Redirector 101 can be implemented by a browser plug-in (e.g. BHO) that modifies the URL call to a protected site, e.g. “Rapport://”, together with registering this scheme to the browser as pointing at the Session Shredder. Other myriad ways of implementing this requirement are possible, such as hooking/replacing the existing HTTP and HTTPS protocol handlers, or hooking into a lower level protocol API such as Windows' WinInet. The browser 40 “initiates” the HTTP/HTTPS requests, but it typically delegates the actual handling to lower-level libraries/modules such as WinInet and/or protocol handlers. A preferred Redirector 101 implementation is therefore to interject in the flow of data from the browser 40 to the lower-level libraries and redirect the traffic to the Session Shredder 110. Session Shredder 110 is the main module of the system, where its role is to replace the session token provided by the protected web site with a token index. In this embodiment Session Shredder 110 is comprised of 3 components: Session Table 104, Secure Path 103, and Traffic Processor 102. Session Table 104 manages the temporary storage and retrieval of session tokens and index tokens. It is essentially a table for mapping each token index to its corresponding session token. Secure Path 103 is essentially a stand-alone HTTP+SSL protocol stack. The Secure Path 103 enables the Session Shredder 110 to issue any HTTP/HTTPS request, requiring only TCP/IP services from the operating system. By incorporating the close-set and tightly integrated HTTP+SSL stack of secure path 103, Session Shredder 110 guarantees that no adversary activity can take place in the dispatching phase, i.e. once the logical request has been prepared, and before it is fully encrypted. The Secure Path 103 may be implemented by means of using open source libraries such as OpenSSL and cURL. Traffic Processor 102 implements most of the logic, meaning that it monitors HTTP traffic and can manipulate HTTP requests and HTTP responses (including monitoring and manipulating the HTML pages), in order to replace session tokens with index tokens or vice-versa.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for preventing the theft of a session token comprising the steps of:
a. detecting a submission of a first request from the client's browser to a protected site;
b. redirecting said first request to the traffic processor for monitoring said first request;
c. forwarding said first request from said traffic processor to said protected site;
d. receiving the response containing the session token from said protected site by said traffic processor;
e. storing said session token in the session table;
f. providing a token index for indexing said session token stored in said session table;
g. modifying the content of said response by changing said session token to said token index; and
h. forwarding the modified response from said traffic processor to said browser.

2. A method according to claim 1, further comprising the steps of:
i. attaching by the browser the token index to a second request intended for the protected site;
j. redirecting said second request to the traffic processor by the redirector;
k. modifying said second request by replacing said token index of said second response with the corresponding session token from the session table; and
l. forwarding the modified second request to said protected site;

3. A method according to claim 1, wherein prior to forwarding the first request modifying said first request by deleting the session token.

4. A method according to claim 1 wherein the session table stores more than one session tokens.

5. A method according to claim 1 wherein the forwarding of the request(s) by the traffic processor and the receiving of response(s) from the protected site is done using a secure path.

6. A method according to claim 1 wherein the first request from the client's browser is the login request.
